(19) United States
(12) Patent Application Publication
(10) Pub. No.: US 2018/0101807 A1
(43) Pub. Date: Apr. 12, 2018

(54) HEALTH AND PRODUCTIVITY INSIGHT GENERATION

(71) Applicant: Microsoft Technology Licensing, LLC, Redmond, WA (US)

(72) Inventors: Tachen C. Ni, Bellevue, WA (US); Thomas Michael Josef Zimmermann, Bellevue, WA (US); Ryen William White, Woodinville, WA (US); Jessica Lundin, Seattle, WA (US)

(73) Assignee: Microsoft Technology Licensing, LLC, Redmond, WA (US)

(21) Appl. No.: 15/288,887

(22) Filed: Oct. 7, 2016

(51) Int. Cl. G06Q 10/06; G06F 19/00

(52) U.S. Cl. CPC G06Q 10/06398; G06F 19/322

(57) ABSTRACT

A method for generating productivity insights includes receiving health data for a user of a productivity evaluation service. From the health data, health behaviors and health effects of the user are determined. Productivity data for the user is received, and from the productivity data, productivity behaviors and productivity effects of the user are determined. Associations between changes in the health data and changes in the productivity data are identified. Based on one of the associations, a productivity insight is generated for the user including a prompt to engage in a health behavior that is associated with a desirable productivity effect.

### BACKGROUND

Computing devices can be used to track behaviors and activities over time. For example, a computing device equipped with suitable sensors can track a user's movements, sleep patterns, heart rate, blood pressure, and other health data. Computing devices can also track user location, messages sent and received, calendar events, computing device inputs, and other productivity data.

### BRIEF DESCRIPTION OF THE DRAWINGS

FIG. 1 depicts an example productivity evaluation service receiving health data and productivity data for a user.

FIG. 2 depicts an example method for generating productivity insights for a user.

FIG. 3 depicts generation of a productivity insight.

FIG. 4 depicts presentation of a productivity insight.

FIG. 5 depicts an example method for generating productivity insights for a plurality of users.

FIG. 6 depicts generation of a productivity insight.

FIG. 7 depicts an example computing system.

### DETAILED DESCRIPTION

Employees and employers strive to find ways to improve workplace productivity. More productive workplaces lead to increased profitability and can increase satisfaction, fulfillment and other positive feelings. However, it can be difficult to identify the conditions and behaviors that encourage more productive work, especially given differences in habits, preferences and temperament among workers, among other factors.

On the other hand, an individual's productivity will often be influenced by various behaviors occurring prior to work sessions in which productivity is of interest. The present description is directed to observing these behaviors and causally connecting them to the subsequent productivity. For example, going to bed late can impact an individual's productivity the following day, and establishing such an association can be facilitated by a wearable computing device or smart phone monitoring sleep behavior. As another example, an individual may be generally more productive on days when he goes for a morning jog (e.g., as opposed to exercising in the evening). Such an association may also be facilitated via a personal computing device, for example using an accelerometer-based step tracker. Once accurate associations are established, the user can be provided with actionable prompts that lead to increased productivity. In other words, a determined connection between health behaviors and workplace productivity can be used to encourage positive behaviors that lead to enhanced productivity.

Accordingly, the present discussion relates to collecting health data and productivity data for an individual. After a productivity evaluation service receives such data, it finds associations between changes in the health data and changes in the productivity data, and generates actionable productivity insights that prompt the individual to engage in health behaviors predicted to improve productivity. For example, the productivity evaluation service may determine that a user is generally more productive at work after engaging in a particular health behavior in the morning, and prompt the user to more frequently engage in the particular health behavior. Evaluating productivity in this manner may help improve workplace productivity and profitability, as well as improve the mental and physical health of the workers themselves.

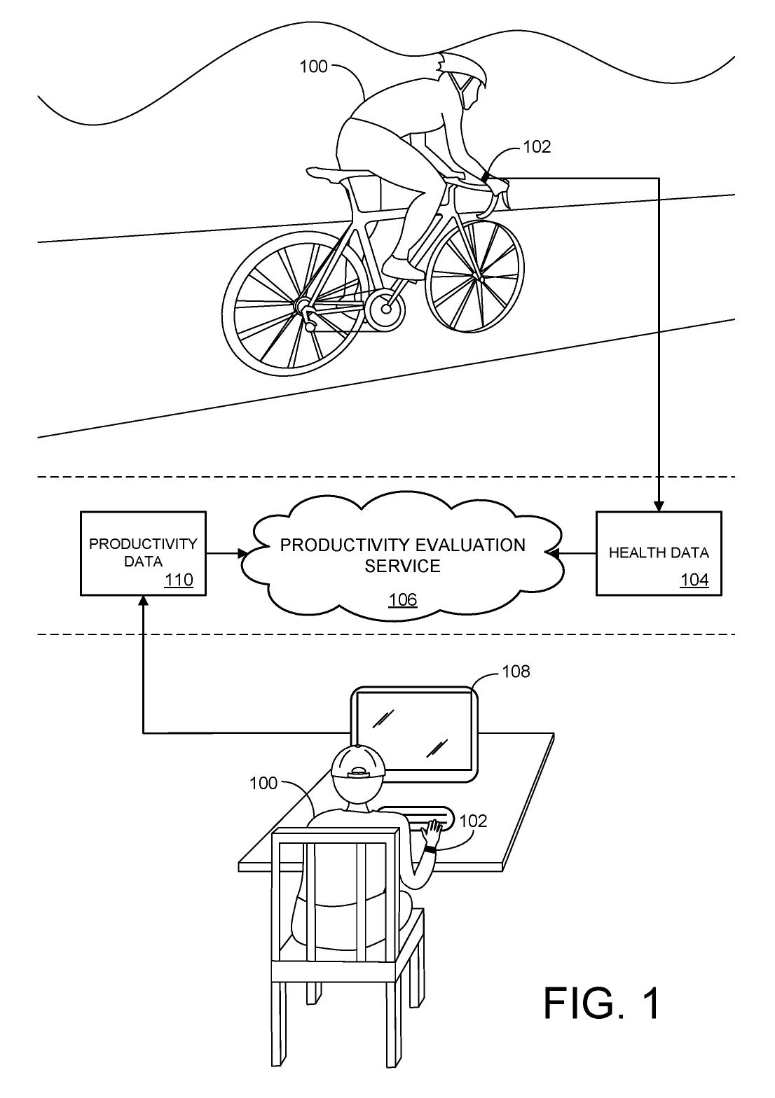

Collection of health data and productivity data is schematically shown in FIG. 1. Specifically, FIG. 1 shows a user 100 of a productivity evaluation service while the user is engaged in various activities, including riding a bicycle and working at a computer. While the user is engaged in these and other activities, computing devices associated with the user may collect a variety of data about the user's current status and behaviors. For example, while user 100 is riding the bicycle, the user is wearing a wearable computing device 102, which may be equipped with a variety of sensors to collect a variety of health data 104. Such health data may then be sent to a productivity evaluation service 106 for interpretation.

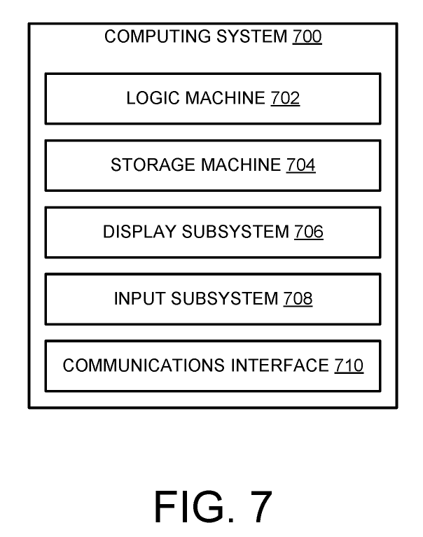

A productivity evaluation service as described herein may be implemented in a variety of ways. For example, a productivity evaluation service may be implemented on one or more server computers configured to receive and process data “in the cloud” via a communications interface, for example. Additionally, or alternatively, a productivity evaluation service may be hosted by a user on the user's personal computing device, hosted by an organization to which the user belongs, and/or implemented on any other computer system. For example, a productivity evaluation service may be implemented as computing system 700 described below with respect to FIG. 7.

A variety of types of information collected by a computing device may be described as health data. For example, health data may include one or more of an exercise metric, a vital signs metric, a sleep metric, a recreational device usage metric, and environmental information. An exercise metric may indicate, for example, how frequently the user exercises, at what times the user exercises, the types of exercise the user performs, an intensity of the user's exercise, a number of steps taken during exercise, a total distance traveled during exercise, calories burned (luring exercise, etc. A vital signs metric may include vital signs of the user, including heart rate, blood pressure, skin temperature, internal temperature, measurements of galvanic skin resistance (GSR), neurological activity of the user, etc. A sleep metric may include the times at which the user fell asleep and woke up, sleep duration, different stages of sleep the user experienced, an indication of a quality of the user's sleep, etc. A recreational device usage metric may indicate which devices the user used recreationally throughout the day (e.g., laptop, tablet computer, television, media center, wearable devices), how long the user spent using each device, what programs/applications/computer files the user accessed, etc. Environmental information of the user may include locations visited by the user over a period of time, ambient temperature, humidity, time spent driving, UV light exposure, allergen exposure, etc.

It will be appreciated that these examples are non-limiting, and health data may include virtually any data relevant to a user's lifestyle or health. As will be described below, health data may be used to determine health behaviors of the user, such as how frequently the user exercises, for example, as well as health effects of the user, including the user's heart rate, blood pressure, sleep quality, stress markers, etc.

Such health data may be collected in a variety of suitable ways, depending on the data collection capabilities of the computing device(s) in use. For example, a computing device may be equipped with one or more accelerometers, gyroscopes, magnetometers, global positioning system (GPS) receivers, light sensors (visible light cameras, ambient light sensors, optical heart rate sensors, ultraviolet sensors, depth cameras, etc.), microphones, barometers, galvanic skin response (GSR) sensors, etc., usable to determine a user's location, speed, vital signs, movements, etc. Such sensors may be included in computing devices having a variety of form factors, including mobile phones, wearable devices, tablet computers, laptop computers, head mounted display devices (HMDs), as well as non-portable devices, including desktop computers, game consoles, media center hardware, etc.

As shown in FIG. 1, computing devices associated with a user may additionally collect data while the user is working. Specifically, user 100 is shown working at computing device 108, while still wearing wearable computing device 102. Either or both of these computing devices may collect productivity data 110 while the user works, and send such data to productivity evaluation service 106.

As with health data, productivity data may take a variety of forms. For example, productivity data may include one or more of a location metric, a workplace device usage metric, messaging activity, and calendar information of the user. A location metric may include a listing of locations visited by the user over time; how much time the user spends at work, at home, in transit, etc.; locations visited within the user's workplace (e.g., the user's office, an office of the user's boss, a company break room); etc. A device usage metric may indicate which work-related computing devices the user used over a period of time (e.g., office computer, a shared presentation device, personal devices used for work-related purposes); software applications used by the user; computer files and directories accessed by the user; inputs provided by the user (e.g., mouse clicks, keyboard inputs, touch events, spoken commands); resources accessed by the user—e.g., websites visited; etc. Messaging activity of the user may include a number of messages received by the user over a period of time, a current number of pending or unread messages of the user, a messaging response time of the user (i.e., an average time between the user receiving a message and the user responding to the message), etc. Calendar information of the user may include upcoming calendar events the user has scheduled, previous calendar events which the user attended, calendar events which the user has declined, etc.

It will be appreciated that these examples are non-limiting, and productivity data may include virtually any data relevant to a user's workplace habits and productivity. In general, productivity data may be used to determine both productivity behaviors and productivity effects of a user.

Similar to health data, productivity data may be collected by a variety of suitable computing devices—computing devices 102 and 108 are not intended to limit the present disclosure. Such computing devices may include sensors and/or software applications configured to track the user's workplace habits. For example, computing device 108 may include one or more messaging clients (e.g., email, social networking services, instant messaging) configured to save a record of messages sent or received by the user. A computing device may additionally be configured to track when the user logs in and out, when the user types/clicks and/or touches a display, what software applications the user uses throughout the day, etc. Further, productivity data may be collected by any/all of the sensors and computing devices described above with respect to health related data.

In some implementations, health data and/or productivity data may be collected whenever a user's computing device is operating, or whenever a particular user is logged in. Alternatively, such data may be collected only when particular applications are running, and/or the user has given explicit permission. For example, the productivity evaluation service may be strictly opt-in only, allowing users to choose which, if any, of their personal data is collected and uploaded. Accordingly, any personal user data collected by a computing device and/or a productivity evaluation service may be anonymized and/or encrypted. In general, user data may be carefully handled and stored so as to respect the privacy of individual users. Again, an opt-in system will often be desirable.

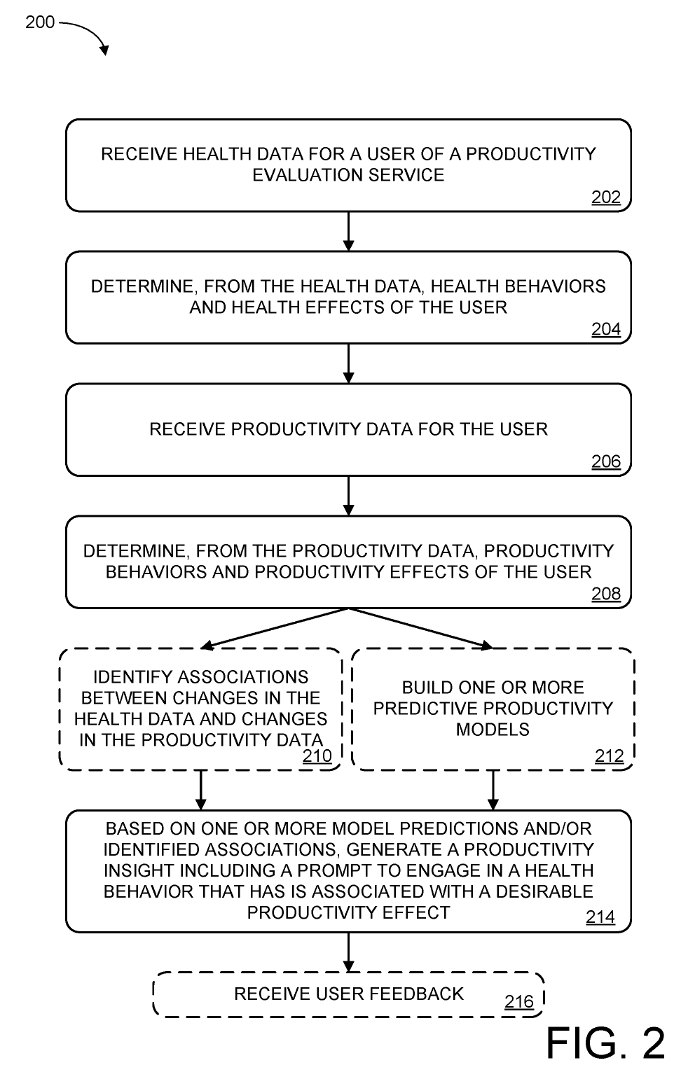

Upon receiving health data and productivity data for a user, a productivity evaluation service may be configured to generate a productivity insight for the user. FIG. 2 illustrates an example method 200 for generating productivity insights. At 202, method 200 includes receiving health data for a user of a productivity evaluation service. As described above, the productivity evaluation service may receive the health data from one or more computing devices associated with the user, and the data collected by these devices may take a variety of forms. Additionally, or alternatively, the productivity evaluation service may receive health data from other sources—e.g., health management apps, electronic medical records, other services to which the user is subscribed, etc.

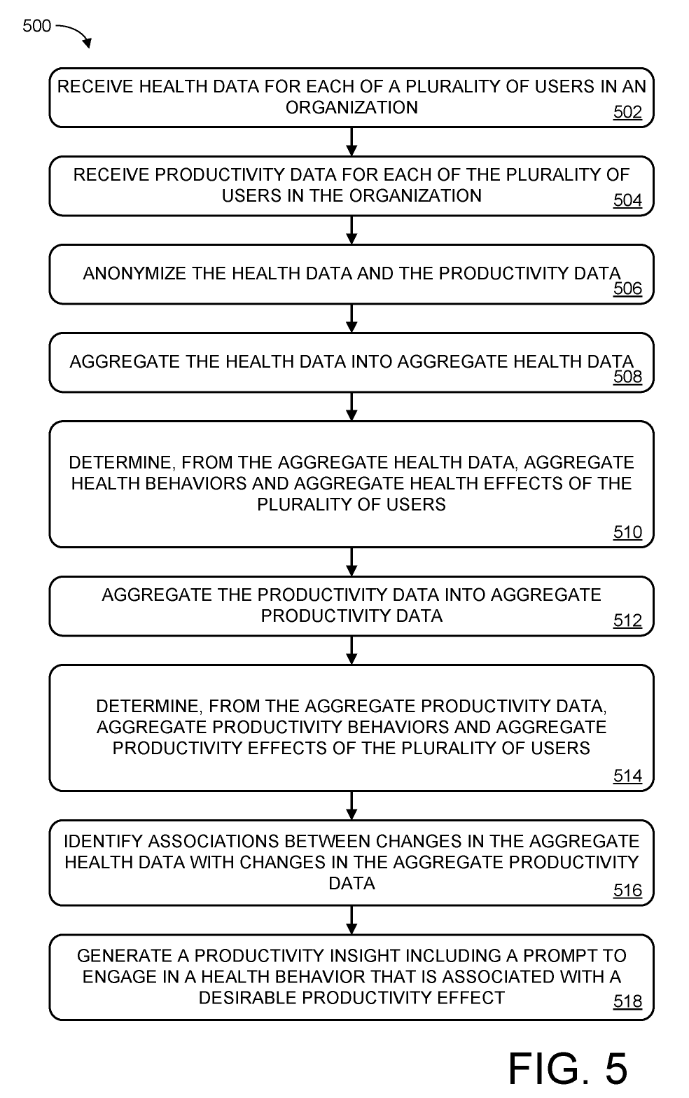

It will be appreciated that while the productivity evaluation service is described as receiving health data and productivity data for a single user, data for multiple users may be received and evaluated. As will be discussed below with respect to FIG. 5, a productivity evaluation service may receive data for a plurality of users, and generate productivity insights for the users as a group.

At 204, method 200 includes determining, from the health data, health behaviors and health effects of the user. For example, GPS information and accelerometer information may indicate that a user was moving during a period of time, though some amount of processing may be required in order to determine whether the user was walking, cycling, driving a car, etc. The nature of a user's movement may be characterized as a health behavior. Similarly, data collected by a wearable device may be processed to determine at what time a user went to sleep, at what time the user woke up, and a relative quality of the user's sleep. The user's sleep quality may be characterized as a health effect, for example. Such processing may be done by the productivity evaluation service, in which case the health behaviors and health effects are inferred from the health data by the service. Additionally, or alternatively, some amount of processing of health data may occur on any or all of the computing devices that collect such data. Accordingly, health behavior and health effects may be received by the productivity evaluation service, and/or derived from the health data after it is received.

At 206, method 200 includes receiving productivity data for the user of the productivity evaluation service. As described above, the productivity evaluation service may receive the productivity data from one or more computing devices associated with the user, and the data collected by these devices may take a variety of forms. Additionally, or alternatively, the productivity evaluation service may receive productivity data from other sources—e.g., social networking sites, time management services, company records, etc.

At 208, method 200 includes determining, from the productivity data, productivity behaviors and productivity effects of the user. As with health behaviors and effects, productivity behaviors and effects may be inferred by a productivity evaluation service based on received productivity data, and/or some amount of processing of productivity data may occur before the data is received by the service. For example, productivity data may indicate that a user visited a particular website at a particular time, though additional processing may be required in order to determine whether this visit was work related. Similarly, based on locations visited by the user, it may be determined whether time the user spent outside of his office was productive (i.e., in a meeting) or nonproductive (i.e., visiting a friend who is on a different project team). Similar processing may be done to determine whether the user's phone calls were productive, whether the user arrived and left work on time, whether the user responded to messages in a timely manner, etc. Evaluations of the user's productivity may be inferred based on data sent to the productivity evaluation service, and/or determined by the computing device that sends the data.

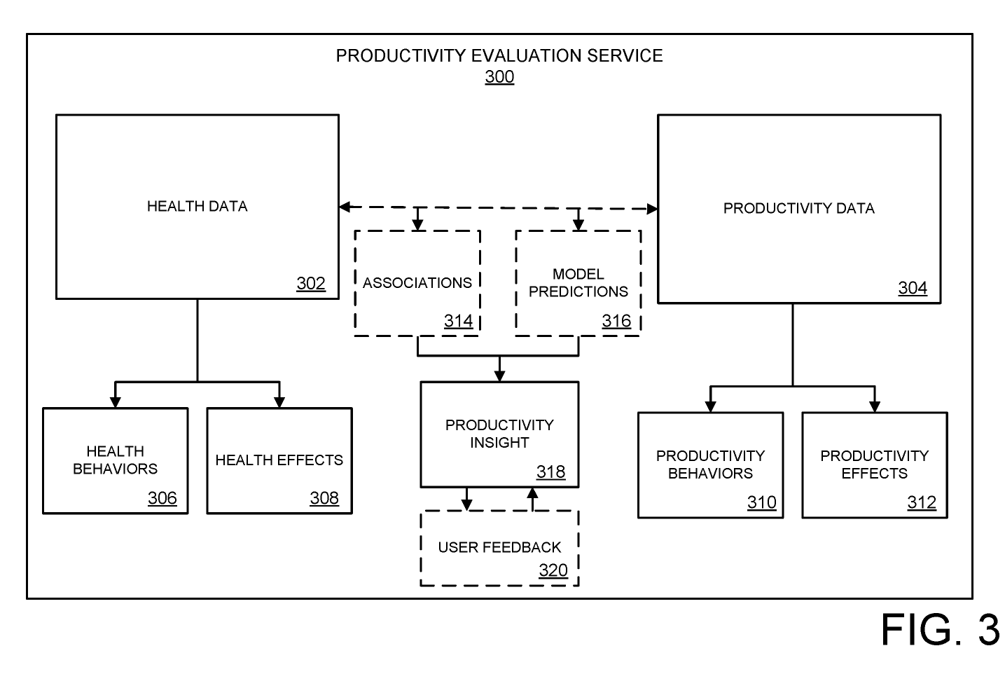

At 210, method 200 optionally includes identifying associations between changes in the health data and changes in the productivity data. This is schematically illustrated in FIG. 3. As shown, a productivity evaluation service 300 includes health data 302 and productivity data 304 for a particular user. From health data 302, productivity evaluation service 300 has inferred health behaviors 306 and health effects 308. Similarly, from productivity data 304, productivity behaviors 310 and productivity effects 312 have been inferred.

In order to generate a productivity insight for the user, the productivity evaluation service 300 identifies associations 314 between changes in the health and productivity data of the user. As the productivity evaluation service receives health and productivity data of the user, it may over time identify changes in the user's health and productivity behaviors and effects. For example, the user may exercise at different times on different days, the user may have variable sleep patterns, the user's blood pressure may fluctuate, etc. Similarly, the user may arrive to work earlier on some days than others, spend more time on certain days browsing non-work websites, etc. Over time, associations between the user's health data and productivity data may be identified by the productivity evaluation service. For example, the service may determine that the user responds to emails more quickly and spends less time visiting non-productive websites when the user sleeps for at least 8 hours. As another example, the service may determine that the user tends to spend relatively less time in his office and more time in nonproductive locations when the user does not exercise in the mornings. In further examples, the system may determine that improved productivity is associated with better quality sleep, earlier wakeup time, different types of exercise, different exercise intensity, etc. It will be appreciated that these examples are non-limiting, and that virtually any health behavior of a user may be associated with any productivity behavior/effect/outcome.

At 212, method 200 optionally includes building one or more predictive productivity models for generating productivity insights. Such models may be built based in part on machine-learning and/or artificial intelligence techniques. It will be appreciated that a variety of suitable machine learning and/or artificial intelligence techniques may be used to identify complex causal relationships between changes in health data and corresponding changes in productivity data, and that any such techniques may be implemented here. For example, such techniques may include exploratory factor analysis, multiple correlation analysis, support vector machine, boosted decision trees, generalized linear models, partial least square classification or regression, branch-and-bound algorithms, clustering models, association rule learning, symbolic computation engines, neural network models, deep neural networks, convolutional deep neural networks, deep belief networks, and/or recurrent neural networks.

At 214, method 200 includes generating a productivity insight based on one or more model predictions and/or identified associations, the productivity insight including a prompt to engage in a health behavior that is associated with a desired productivity effect. As illustrated in FIG. 3, upon identifying associations 314 between changes in health data 302 and productivity data 304, and/or model predictions 316 of a predictive productivity model, the productivity evaluation service generates a productivity insight 318. The productivity insight may include a prompt or suggestion to the user including one or more changes in health behavior and/or work behavior that are likely to improve productivity. For example, the productivity insight may recommend that the user get more sleep, as doing so would likely improve the user's responsiveness to work messages. In other words, a change in the user's health behavior (i.e., more sleep) is predicted to have a desirable productivity effect (i.e., increased messaging responsiveness). Similarly, a productivity insight may suggest that the user exercise more often in the mornings (as opposed to later in the day), as doing so is associated with the user spending more time in his office rather than visiting friends (positive productivity effect). In general, a productivity insight may suggest virtually any behavior or behavior change to a user if it is associated with improved productivity, and the example productivity insights described herein are not intended to be limiting.

At 216, method 200 optionally includes receiving user feedback that pertains to the productivity insight. This user feedback may, for example, indicate whether a user felt that a given productivity insight was accurate and/or realistic. Such user feedback may be taken into account during future productivity insight generation. For example, such user feedback may be used to amplify some identified associations, or discard others. Similarly, such user feedback may be used to train one or more machine-learning classifiers of a predictive productivity model. Receiving and evaluating feedback as described herein may allow a productivity evaluation service to “learn” the types of health behaviors that are most strongly associated with desirable productivity behaviors, as well as the types of productivity insights that have the greatest desirable effect on behavior. User feedback is also illustrated in FIG. 3. As shown, productivity evaluation service 300 may receive user feedback 320, and take such feedback into account when generating future productivity insights.

In some implementations, a desired productivity effect may be defined as any change in productivity data that corresponds to improved productivity. In some examples, this may depend on an organizational role of the user. For example, while certain behaviors may be generally interpreted as being productive—e.g., frequent use of work applications or being in the office during appropriate hours—other behaviors may be productive for some users though nonproductive for others. For example, frequent phone usage may correspond to worker productivity for a customer service representative or salesperson, and interpreted as a nonproductive behavior when exhibited by users with little reason to use the phone in their day-to-day activities.

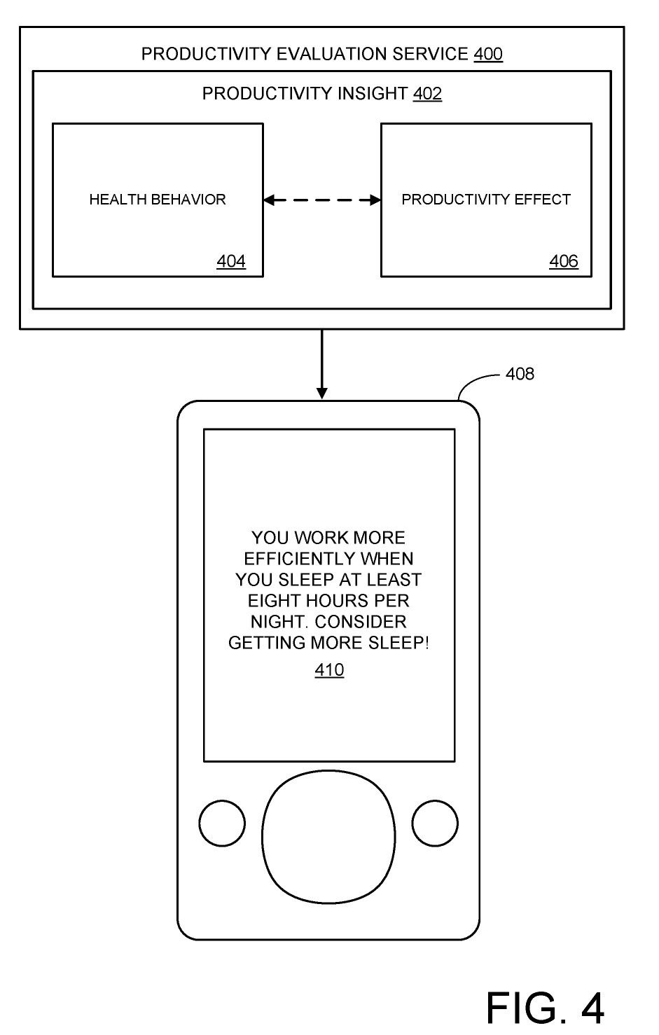

Upon generating the productivity insight, the productivity evaluation service may send the productivity insight to one or more computing devices associated with the user for presentation to the user. This is schematically illustrated in FIG. 4, which again schematically shows a productivity evaluation service 400. Service 400 has generated a productivity insight 402, which indicates that a particular health behavior 404 is associated with a desirable productivity effect 406.

Upon generation of productivity insight 402, the productivity evaluation service may send the insight to a computing device 408 associated with the user. As shown in FIG. 4, the productivity insight includes a prompt 410 that is shown to the user upon presentation of the productivity insight. The prompt includes a suggestion that the user engage in a health behavior (i.e., getting more sleep) in order to achieve a desirable productivity effect (i.e., working more efficiently). It will be appreciated that device 408 is presented for the sake of example, and a variety of different computing devices may be used to receive and view productivity insights.

Productivity insights as described herein may be received and presented in a variety of ways. For example, the productivity insight may be presented as a visible notification on one or more display-equipped computing devices, as shown in FIG. 4. Alternatively, the productivity insight may be automatically presented to the user upon opening an app or visiting a website; sent to the user via text message, email, instant message, etc.; read aloud to the user as an audible notification; and/or presented in any other suitable manner.

The present disclosure focuses primarily on generating productivity insights that describe changes in health and/or work behaviors predicted to improve user productivity. However, it will be appreciated that the data collection and association described herein may additionally or alternatively be used to generate health insights for one or more users. The health insight may be generated based on an identified association and/or predictive health model predictions based on health data and productivity data, and include a prompt to engage in a productivity behavior that is associated with a desired health effect. For example, it may be determined that a user's blood pressure and heart rate increase when the user stays at work late. Accordingly, the health insight may suggest to the user that he makes an effort to leave work at a particular time (i.e., changing his productivity behavior) for the sake of reducing stress (i.e., a desirable health effect). In some embodiments, a productivity evaluation service as described herein may generate health insights instead of or in addition to productivity insights.

As indicated above, in some implementations, a productivity evaluation service may receive health data and productivity data for a plurality of users, and generate productivity insights for the users as a group. For example, each of the users in the plurality may be associated with the same organization (e.g., all employed by the same company, working on the same team, members of the same division). In such examples, a productivity insight may not be specific to any one particular user, but rather provide insights based on behavior of the overall group. For example, if it is determined that, on average, a group of users is more productive when they take a 30-minute break in the mornings, then a productivity insight may be generated for each member of the group, and the insight may suggest taking such breaks with greater frequency.

In some implementations, demographic characteristics of the plurality of users may be taken into account when generating productivity insights. Such demographic characteristics may include, for example, age, gender, ethnicity, height, weight, area of residence, etc. As an example, a productivity evaluation service may determine that mild exercise in the morning improves productivity, though only for female users of a certain age range. Accordingly, the productivity evaluation service may generate a productivity insight for only such users. Accordingly, productivity insights may be generated for three or more group sizes, including productivity insights for a single individual (i.e., group size of one) described above, productivity insights for a cohort of similar users (e.g., similar demographic characteristics), and/or productivity insights for a population of diverse users.

FIG. 5 illustrates an example method 500 for generating a productivity insight for a plurality of users in an organization. At 502, method 500 includes receiving health data for each of the plurality of users in the organization. Such data may be collected and sent to the productivity evaluation service by computing devices associated with each user, as described above.

At 504, method 500 includes receiving productivity data for each of the plurality of users in the organization. As with the health data, the productivity data may be collected by a variety of computing devices associated with each user, and sent to the productivity evaluation service for interpretation.

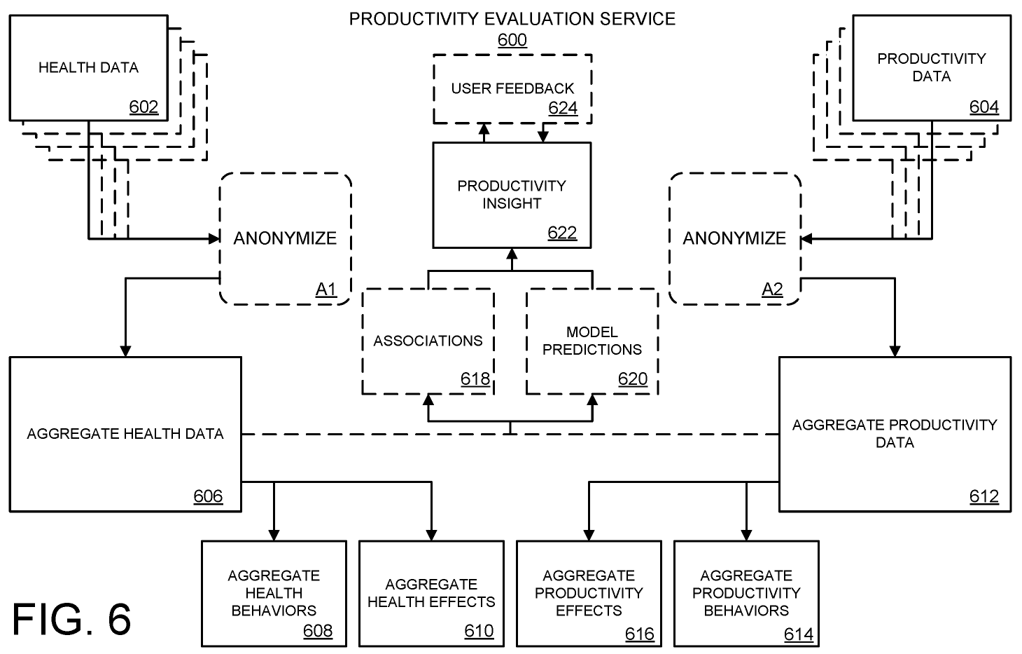

At 506, method 500 includes anonymizing the health data and the productivity data for each user. This is shown in FIG. 6, which includes a productivity evaluation service 600 with several sets of health data 602 and productivity data 604. Each set of data received by service 600 may correspond to a different user in the organization. At A1 and A2, the health data and productivity data for each user is anonymized. This may be done in a variety of suitable ways using anonymization techniques known in the art. In general, after anonymization, the content of the health data and the productivity data may remain relatively unchanged, after removing any potentially user-identifying information.

Turning back to FIG. 5, at 508, method 500 includes aggregating the health data into aggregate health data. Aggregating data as described herein may be done in a variety of suitable ways. In general, aggregating data refers to packaging or grouping the data into a single set that can be evaluated and interpreted on its own, rather than as a plurality of independent datasets. Aggregation of data is schematically shown in FIG. 6, in which health data 602 for each user is aggregated into a single set of aggregate health data 606.

At 510, method 500 includes determining, from the aggregate health data, aggregate health behaviors and aggregate health effects of the plurality of users. This is schematically shown in FIG. 6, in which aggregate health behaviors 608 and aggregate health effects 610 have been inferred from aggregate health data 606. For example, aggregate health behaviors may indicate how frequently, on average, users exercise, while aggregate health effects may indicate an average heart rate or blood pressure for the group as a whole. As described above, processing of health data may be done by one or both of the productivity evaluation services and the computing device(s) collecting the data.

At 512, method 500 includes aggregating the productivity data into aggregate productivity data. This may be done in a similar manner to aggregation of health data described above, and result in a single set of productivity data that can be evaluated and interpreted as a whole. As shown in FIG. 6, after being anonymized at A2, productivity data 604 is aggregated into aggregate productivity data 612.

At 514, method 500 includes determining, from the aggregate productivity data, aggregate productivity behaviors and aggregate productivity effects of the plurality of users. This is shown in FIG. 6, in which aggregate productivity behaviors 614 and aggregate productivity effects 616 have been inferred from the aggregate productivity data. As with the aggregate health behaviors and effects, productivity effects may indicate average behaviors or attributes of the group as a whole—for example, an average arrival time of the group of users, or an average messaging response time.

At 516, method 500 includes identifying associations between changes in the aggregate health data with changes in the aggregate productivity data. This may be done in a substantially similar manner as described above with respect to generating productivity insights for single individuals. In particular, the productivity evaluation service may build one or more predictive productivity models, and this may be done in addition to or as an alternative to identifying associations. Due to the natural variability in a given individual's lifestyle and work habits, eventually the productivity evaluation service may identify associations and/or predict causal relationships between health data and productive data. In some implementations, some degree of averaging or smoothing may be performed on the aggregate data before associations are identified, so as to reduce the impact of any potential outliers. In FIG. 6, associations 618 are identified between the aggregate health data and the aggregate productivity data. Additionally, FIG. 6 shows model predictions 620, which may be used in addition to or instead of associations 618 to generate a productivity insight.

At 518, method 500 includes generating a productivity insight including a prompt to engage in a health behavior that is associated with a desired productivity effect. In some implementations, this productivity insight may be sent to computing devices associated with each user of the plurality. Additionally, or alternatively, such a productivity insight may be sent out via a company mailing list, posted on a company employee forum, etc. As described above, productivity insights generated for a group of users may not be specific to any particular user, though may include a prompt to engage in a behavior predicted to improve the productivity of the group overall. Generation of a productivity insight for a group of users is schematically shown in FIG. 6, in which productivity insight 622 is generated based on one or more of the identified associations 618. As described above, a productivity evaluation service may optionally receive user feedback 624, and take such user feedback into account when generating future productivity insights. This may allow the productivity evaluation service to over time generate more and more accurate and useful productivity insights for the group of users.

In some implementations, a productivity insight may only be generated if the number of users in the group exceeds a threshold. This may be done so as to ensure that the group includes a representative sample of users, helping to improve the applicability of any generated productivity insights. Additionally, ensuring a large group size may reduce the risk that any generated insights allow individuals to infer the health or productivity behaviors of any individual members of the group. In some implementations, the productivity insight may only be generated if the group includes at least a threshold number of users having the same or similar job roles, users located in the same geographic location, users working in the same building, etc., in addition to or as an alternative to ensuring that the group has a minimum number of users.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. For example, computing system 700 may be configured to receive health data and productivity data, and generate productivity insights as described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communications interface 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. Logic machine 702 may be configured to perform one or more of the productivity insight generation techniques described above. In particular, logic machine 702 may be configured to utilize one or more machine learning and/or artificial intelligence algorithms to predict causal relationships between health and productivity behaviors.

The logic machine may include one or more processors configured to execute software instructions. Additionally, or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communications interface 710 may be configured to communicatively couple computing system 700 with one or more other computing devices. Communications interface 710 may include wired and/or wireless communication devices compatible with one or more different communication protocols. As non-limiting examples, the communications interface may be configured for communication via a wireless telephone network, or a wired or wireless local- or wide-area network. In some embodiments, the communications interface may allow computing system 700 to send and/or receive messages, health data, productivity data, and/or productivity/health insights to and/or from other devices via a network such as the Internet.

In an example, a method for generating productivity insights comprises: receiving health data for a user of a productivity evaluation service; determining, from the health data, health behaviors and health effects of the user; receiving productivity data for the user; determining, from the productivity data, productivity behaviors and productivity effects of the user; identifying associations between changes in the health data and changes in the productivity related data; and based on one or more of the identified associations, generating a productivity insight for the user, such insight including a prompt to engage in a health behavior that is associated with a desirable productivity effect. In this example or any other example, the desirable productivity effect is dependent on an organizational role of the user. In this example or any other example, the method further comprises anonymizing the health data and productivity data for the user, and aggregating the health data and productivity data with health data and productivity data for a plurality of other users, resulting in aggregate health data and aggregate productivity data. In this example or any other example, the method further comprises identifying associations between changes in the aggregate health data and changes in the aggregate productivity data, and generating a productivity insight for the plurality of users based on one of the associations. In this example or any other example, the health data and the productivity data are received from one or more computing devices associated with the user. In this example or any other example, the method further comprises sending the productivity insight to one or more computing devices associated with the user for presentation to the user. In this example or any other example, the method further comprises generating a health insight for the user based on one or more of the identified associations, such insight including a prompt to engage in a productivity behavior that is associated with a desirable health effect. In this example or any other example, the health data includes one or more of an exercise metric, a vital signs metric, a sleep metric, a recreational device usage metric, and environmental information. In this example or any other example, the productivity data includes one or more of a location metric, a workplace device usage metric, messaging activity, and calendar information of the user.

In an example, a computing device comprises: a logic machine; and a storage machine holding instructions executable by the logic machine to: receive health data for a user of a productivity evaluation service; determine, from the health data, health behaviors and health effects of the user; receive productivity data for the user; determine, from the productivity data, productivity behaviors and productivity effects of the user; identify associations between changes in the health data with changes in the productivity data; and generate a productivity insight for the user based on one of the identified associations, such insight including a prompt to engage in a health behavior that is associated with a desirable productivity effect. In this example or any other example, the desirable productivity effect is dependent on an organizational role of the user. In this example or any other example, the computing device further comprises a communications interface configured to receive the health data and the productivity data from one or more computing devices associated with the user, and further configured to send the productivity insight to the one or more computing devices for presentation to the user. In this example or any other example, the instructions are further executable to anonymize the health data and the productivity data for the user, and aggregate the health data and productivity data with health data and productivity data for a plurality of other users, resulting in aggregate health data and aggregate productivity data. In this example or any other example, the instructions are further executable to identify associations between changes in the aggregate health data and changes in the aggregate productivity data, and generate a productivity insight for the plurality of users based on one of the associations. In this example or any other example, the instructions are further executable to generate a health insight for the user based on one of the identified associations, such insight including a prompt to engage in a productivity behavior that is associated with a desirable health effect. In this example or any other example, the health data includes one or more of an exercise metric, a vital signs metric, a sleep metric, a recreational device usage metric, and environmental information. In this example or any other example, the productivity data includes one or more of a location metric, a workplace device usage metric, messaging activity, and calendar information of the user.

In an example, a method for generating productivity insights comprises: receiving health data for each of a plurality of users in an organization; receiving productivity data for each of the plurality of users in the organization; anonymizing the health data and the productivity data; aggregating the health data into aggregate health data; determining, from the aggregate health data, aggregate health behaviors and aggregate health effects of the plurality of users; aggregating the productivity data into aggregate productivity data; determining, from the aggregate productivity data, aggregate productivity behaviors and aggregate productivity effects of the plurality of users; identifying associations between changes in the aggregate health data with changes in the aggregate productivity data; and generating a productivity insight for the plurality of users based on one of the identified associations, such insight including a prompt to engage in a health behavior that is associated with a desirable productivity effect. In this example or any other example, the productivity insight is generated based on the plurality of users in the organization including at least a threshold number of users. In this example or any other example, the method further comprises sending the productivity insight to one or more computing devices associated with each of the plurality of users.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for generating productivity insights, comprising:
receiving health data for a user of a productivity evaluation service;
determining, from the health data, health behaviors and health effects of the user;
receiving productivity data for the user;
determining, from the productivity data, productivity behaviors and productivity effects of the user;
identifying associations between changes in the health data and changes in the productivity related data; and
based on one or more of the identified associations, generating a productivity insight for the user, such insight including a prompt to engage in a health behavior that is associated with a desirable productivity effect.

2. The method of claim 1, where the desirable productivity effect is dependent on an organizational role of the user.

3. The method of claim 1, further comprising anonymizing the health data and productivity data for the user, and aggregating the health data and productivity data with health data and productivity data for a plurality of other users, resulting in aggregate health data and aggregate productivity data.

4. The method of claim 3, further comprising identifying associations between changes in the aggregate health data and changes in the aggregate productivity data, and generating a productivity insight for the plurality of users based on one of the associations.

5. The method of claim 1, where the health data and the productivity data are received from one or more computing devices associated with the user.

6. The method of claim 1, further comprising sending the productivity insight to one or more computing devices associated with the user for presentation to the user.

7. The method of claim 1, further comprising generating a health insight for the user based on one or more of the identified associations, such insight including a prompt to engage in a productivity behavior that is associated with a desirable health effect.

8. The method of claim 1, where the health data includes one or more of an exercise metric, a vital signs metric, a sleep metric, a recreational device usage metric, and environmental information.

9. The method of claim 1, where the productivity data includes one or more of a location metric, a workplace device usage metric, messaging activity, and calendar information of the user.

10. A computing device, comprising:
a logic machine; and
a storage machine holding instructions executable by the logic machine to:
receive health data for a user of a productivity evaluation service;
determine, from the health data, health behaviors and health effects of the user;
receive productivity data for the user;
determine, from the productivity data, productivity behaviors and productivity effects of the user;
identify associations between changes in the health data with changes in the productivity data; and
generate a productivity insight for the user based on one of the identified associations, such insight including a prompt to engage in a health behavior that is associated with a desirable productivity effect.

11. The computing device of claim 10, where the desirable productivity effect is dependent on an organizational role of the user.

12. The computing device of claim 10, further comprising a communications interface configured to receive the health data and the productivity data from one or more computing devices associated with the user, and further configured to send the productivity insight to the one or more computing devices for presentation to the user.

13. The computing device of claim 10, where the instructions are further executable to anonymize the health data and the productivity data for the user, and aggregate the health data and productivity data with health data and productivity data for a plurality of other users, resulting in aggregate health data and aggregate productivity data.

14. The computing device of claim 13, where the instructions are further executable to identify associations between changes in the aggregate health data and changes in the aggregate productivity data, and generate a productivity insight for the plurality of users based on one of the associations.

15. The computing device of claim 10, where the instructions are further executable to generate a health insight for the user based on one of the identified associations, such insight including a prompt to engage in a productivity behavior that is associated with a desirable health effect.

16. The computing device of claim 10, where the health data includes one or more of an exercise metric, a vital signs metric, a sleep metric, a recreational device usage metric, and environmental information.

17. The computing device of claim 10, where the productivity data includes one or more of a location metric, a workplace device usage metric, messaging activity, and calendar information of the user.

18. A method for generating productivity insights, comprising:
receiving health data for each of a plurality of users in an organization;
receiving productivity data for each of the plurality of users in the organization;
anonymizing the health data and the productivity data;
aggregating the health data into aggregate health data;
determining, from the aggregate health data, aggregate health behaviors and aggregate health effects of the plurality of users;
aggregating the productivity data into aggregate productivity data;
determining, from the aggregate productivity data, aggregate productivity behaviors and aggregate productivity effects of the plurality of users;
identifying associations between changes in the aggregate health data with changes in the aggregate productivity data; and
generating a productivity insight for the plurality of users based on one of the identified associations, such insight including a prompt to engage in a health behavior that is associated with a desirable productivity effect.

19. The method of claim 18, where the productivity insight is generated based on the plurality of users in the organization including at least a threshold number of users.

20. The method of claim 18, further comprising sending the productivity insight to one or more computing devices associated with each of the plurality of users.
